(19) United States
(12) Patent Application Publication
(10) Pub. No.: US 2009/0265407 A1
(43) Pub. Date: Oct. 22, 2009

(54) Method and System For Determining Altitude, Longitude, and Lattitude From Earth Orthogonal Coordinate System

(75) Inventors: Safet SH Hodzic, Colorado Springs, CO (US); Harry Melville Dougherty, III, Colorado Springs, CO (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/107,229

(22) Filed: Apr. 22, 2008

(51) Int. Cl. G06F 7/548

(52) U.S. Cl. 708/442

(57) ABSTRACT

A method and system for a method and system is provided for transforming geocentric, rectangular coordinates to geodetic coordinates. A meridian plane containing a given point reckoned in geocentric rectangular coordinates is determined, and a line though the given point and normal to a reference ellipsoid of a geodetic coordinate system is determined. An algebraic solution to intersection of the line with the reference ellipsoid is used to determine the coordinates of the point of intersection, which in turn are used to determine the geodetic latitude and altitude of the given point.

### FIELD OF THE INVENTION

The present invention relates to a method and system for determining altitude, longitude, and latitude for a location having known coordinates in a geocentric, orthogonal coordinate system.

### BACKGROUND

Accurate determination of geographic location has many practical uses and is fundamental to many applications, including navigation, emergency services, facilities placement, and cartography, to name only a few. Typically, geographic location is measured in latitude above (or below) the Earth's equator, longitude with respect to a prime meridian (origin in longitude), and altitude above the surface of the Earth.

More specifically, geographic location is commonly reckoned with respect to a geodetic coordinate system in which a reference ellipsoid represents an idealized (smooth) figure of the Earth. The reference ellipsoid is characterized by rotational symmetry about a polar axis such that the minor axis of the ellipsoid coincides with the polar axis and the major axis of the ellipsoid lies in an equatorial plane that is perpendicular to the polar axis. Thus, the intersection of the ellipsoid with the equatorial plane is a circle having a diameter equal to the major axis. The intersection of the equatorial plane with the polar axis is the origin of the geodetic coordinate system, and typically also coincides with the center of mass of the Earth. Geodetic longitude is measured in the equatorial plane as an azimuthal angle about the polar axis, geodetic latitude is measured as an angle above or below the equatorial plane, and geodetic altitude is measured as a normal distance above or below the surface of the ellipsoid.

The actual values of the major and minor axes of the reference ellipsoid, as well as the locations and orientations of reference axes with respect to which latitude and longitude are measured comprise elements of the particular reference coordinate system used. These values are generally determined by various geological surveys, surveys of the Earth's rotation, and measurements of the Earth's orientation with respect to a celestial coordinate system based on visible stars, for example.

Geographic location may also be reckoned with respect to geocentric, rectangular coordinate system comprising mutually orthogonal axes X, Y and Z. In such a coordinate system the Z-axis typically coincides with the polar axis, while the X-Y plane coincides with the equatorial plane of the ellipsoid (or of the Earth). The +X-axis is usually taken to be the intersection of the prime meridian plane with the equatorial plane, and the origin is again taken to coincide with the center of mass of the Earth.

### SUMMARY

In some situations, geographic location may be known, determined, or given in the geocentric, rectangular coordinate system, but not in latitude, longitude and altitude of the geodetic coordinate system. In order to reckon the same location in the geodetic coordinate system, the rectangular coordinates need to be transformed to the geodetic coordinates. While various mathematical methods exist for performing such a transformation, they generally involve some form of approximation and/or iteration formulae. As a consequence, existing methods may be subject to certain inaccuracies or computational inefficiencies. Therefore, a need exists for efficient means of transforming rectangular coordinates of a geographic location to geodetic coordinates using an explicit, closed-form mathematical formulation that avoids the necessity of approximation and iteration.

Accordingly, various embodiments of the present invention provide a method and system for transforming geocentric, rectangular coordinates to geodetic coordinates.

Hence, in one respect, a method of transforming and outputting geographic location coordinates is provided, wherein the method is carried out in a system comprising a computer processor coupled with a computer-readable storage medium. The method may be implemented in a computer program (i) comprising machine-language logic instructions stored on the computer-readable storage medium and (ii) being executable by the computer processor, and comprises: providing to the computer program spatial coordinates of a given point reckoned in a geocentric rectangular coordinate system, the geocentric rectangular coordinate system comprising three mutually orthogonal axes X, Y, and Z, wherein the spatial coordinates of the given point are X=x₀, Y=y₀, and Z=z₀; providing a geodetic coordinate system comprising a reference ellipsoid with (i) a center at X=0, Y=0, and Z=0, (ii) an equatorial plane coincident with the X-Y plane, (iii) a semi-major axis a in the equatorial plane and (iv) a semi-minor axis b in the Z-axis, the ellipsoid thereby being of the form:

$$\frac{{X}^{2}}{{a}^{2}} + \frac{{Y}^{2}}{{a}^{2}} + \frac{{Z}^{2}}{{b}^{2}} = 1 ,$$

the surface of the reference ellipsoid being a smooth representation of the surface of the Earth; in the geodetic coordinate system, determining a meridian plane containing the given point; determining spatial coordinates X=x₁, Y=y₁, and Z=z₁ of a second point lying on the ellipsoid, wherein a line passing through both the second point and the given point lies in the meridian plane and is normal to the ellipsoid at the second point; storing machine-logic representations of x₁, y₁, and z₁ in the computer-readable storage medium; determining a geodetic longitude λ₀ of the given point from a longitude function Λ (X, Y) evaluated at X=x₀ and Y=y₀ according to λ₀=Λ(x₀, y₀)=tan⁻¹(y₀/x₀); determining a geodetic latitude φ₀ of the given point using the stored representations of x₁, y₁, and z₁ to evaluate a latitude function φ (X, Y, Z) at X=x₁, Y=y₁, and Z=z₁, the latitude function giving an angle between the line and the equatorial plane at a point of intersection between the line and the equatorial plane; determining a geodetic altitude h₀ of the given point using the stored representations of x₁, y₁, and z₁ to evaluate an altitude function H(X, Y, Z) at X=x₁, Y=y₁, and Z=z₁, the altitude function giving a length of the line between the given point and the second point; and outputting a signal representing the determined geodetic latitude φ₀, longitude λ₀, and altitude h₀, wherein φ₀, λ₀, and h₀ are the spatial coordinates of the given point transformed to coordinates of the geodetic coordinate system.

In another respect, a system for transforming and outputting geographic location coordinates is provided, wherein the system comprises: a computer-readable storage medium; a computer processor coupled with the computer-readable storage medium; machine-language logic instructions stored on the computer-readable storage medium and executable by the computer processor to: receive spatial coordinates of a given point reckoned in a geocentric rectangular coordinate system, the geocentric rectangular coordinate system comprising three mutually orthogonal axes X, Y, and Z, wherein the spatial coordinates of the given point are X=x₀, Y=y₀, and Z=z₀; render a geodetic coordinate system comprising a reference ellipsoid with (i) a center at X=0, Y=0, and Z=0, (ii) an equatorial plane coincident with the X-Y plane, (iii) a semi-major axis a in the equatorial plane and (iv) a semi-minor axis b in the Z-axis, the ellipsoid thereby being of the form:

$$\frac{{X}^{2}}{{a}^{2}} + \frac{{Y}^{2}}{{a}^{2}} + \frac{{Z}^{2}}{{b}^{2}} = 1 ,$$

the surface of the reference ellipsoid being a smooth representation of the surface of the Earth; determine a meridian plane containing the given point; determine spatial coordinates X=x₁, Y=y₁, and Z=z₁ of a second point lying on the ellipsoid, wherein a line passing through both the second point and the given point lies in the meridian plane and is normal to the ellipsoid at the second point; store machine-logic representations of x₁, y₁, and z₁ in the computer-readable storage medium; determine a geodetic longitude λ₀ of the given point from a longitude function Λ(X, Y) evaluated at X=x₀ and Y=y₀ according to λ₀=Λ(x₀, y₀)=tan⁻(y₀/x₀); determine a geodetic latitude φ₀ of the given point using the stored representations of x₁, y₁, and z₁ to evaluate a latitude function φ(X, Y, Z) at X=x₁, Y=y₁, and Z=z₁, the latitude function giving an angle between the line and the equatorial plane at a point of intersection between the line and the equatorial plane; determine a geodetic altitude h₀ of the given point using the stored representations of x₁, y₁, and z₁ to evaluate an altitude function H(X, Y, Z) at X=x₁, Y=y₁, and Z=z₁, the altitude function giving a length of the line between the given point and the second point; and output a signal representing the determined geodetic latitude φ₀, longitude λ₀, and altitude h₀, wherein φ₀, λ₀, and h₀ are the spatial coordinates of the given point transformed to coordinates of the geodetic coordinate system.

These as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate the invention by way of example only and, as such, that numerous variations are possible. For instance, structural elements and process steps can be rearranged, combined, distributed, eliminated, or otherwise changed, while remaining within the scope of the invention as claimed.

### BRIEF DESCRIPTION OF THE DRAWINGS

FIG. 1 is depicts the World Geodetic System (WGS) 84 Coordinate System.

FIG. 2 illustrates the relationship between geodetic latitude of a given point, a line normal to the surface of the reference ellipsoid and through the given point, and the tangent to the ellipsoid.

FIG. 3 illustrates the geometry of the transformation from geocentric rectangular coordinates to geodetic latitude, longitude, and altitude.

FIG. 4 illustrates an exemplary embodiment of the method of transforming geocentric rectangular coordinates to geodetic latitude, longitude, and altitude.

FIG. 5 illustrates an exemplary location device that represents exemplary means for the method of transforming geocentric rectangular coordinates to geodetic latitude, longitude, and altitude.

### DETAILED DESCRIPTION

The form of the transformation described herein is dependent on the relationship between the geocentric, rectangular coordinate system in which coordinates of a given point are reckoned and the geodetic coordinate system in which the transformed coordinates of the given point are desired, and on the parameters that describe each coordinate system. Numerous reference coordinate systems exist for which the appropriate relationships may be established, and to which the method and system described herein may be applied. For purposes of illustration and explanation, the geodetic coordinate system employed in the embodiments disclosed herein of the present invention is taken by way of example to be the World Geodetic System (WGS) 84 Coordinate System, commonly referred to as “WGS 84.” WGS 84 is defined in National Imagery and Mapping Agency Technical Report TR 8350.2, which is incorporated herein by reference, and is publically available from the National Imagery and Mapping Agency, Bethesda, Md.

Over the span of many years and by international scientific agreement, WGS 84, which follows criteria outlined by the International Earth Rotation Services (IERS), has gained widespread acceptance as a standard reference model for reckoning geodetic coordinates. It should be understood, however, that its use in the context of the embodiments described herein is exemplary, and that the use of other geodetic coordinate systems would remain within the scope and spirit of the present invention.

### 1. WGS 84 Coordinate System

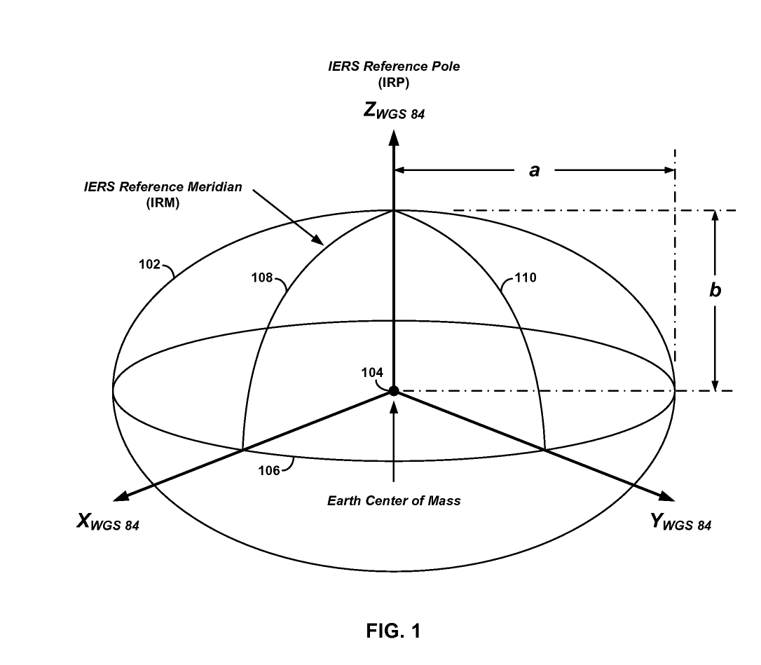

FIG. 1 illustrates the WGS 84 coordinate system. Consistent with the general description above of a geodetic coordinate system, WGS includes mutually orthogonal axes X, Y, and Z, and a reference ellipsoid 102 centered at the origin 104 of the XYZ coordinate system. The WGS 84 ellipsoid is rotationally symmetric about the polar axis, which is defined according to the IERS Reference Pole (IRP). The polar axis is also coincident with the Z-axis of the rectangular coordinate system. Also as described above, the equatorial plane 106 of the reference ellipsoid is coincident with the X-Y plane of the rectangular coordinate system, while the origin 104 of WGS 84 corresponds to the center of mass of the Earth. As shown, the reference ellipsoid has a semi-major axis a that lies in the equatorial plane, and a semi-minor axis b that is coincident with the polar axis. The intersection of the equatorial plane with the reference ellipsoid is a circle with a radius equal to the semi-major axis. In mathematical terms, the reference ellipsoid may be described according to the equation:

$$\frac{{X}^{2}}{{a}^{2}} + \frac{{Y}^{2}}{{a}^{2}} + \frac{{Z}^{2}}{{b}^{2}} = 1. \qquad ( 1 )$$

In such a system, a meridian plane is a plane that is bounded along one edge by the polar axis (or the Z-axis), but extends unbounded in the other co-planar directions. As such, a meridian plane is perpendicular to the equatorial plane. A prime meridian plane defines a reference meridian plane and reference direction in the coordinate system. Specifically, the prime meridian plane is coincident with the X-Z plane of the rectangular coordinate system. The intersection of a meridian plane with the ellipsoid defines a meridian, the prime meridian 108 (or “IERS Reference Meridian”) being the intersection of the ellipsoid with the prime meridian plane.

As shown in the figure, the X-axis is coincident with the intersection of the prime meridian plane with the equatorial plane, and Y-axis is coincident with the intersection of the equatorial plane with Y-Z plane. Also as shown, the +X direction points from the origin through the prime meridian. Geodetic longitude λ is then defined as the azimuthal angle in the X-Y plane about the polar axis, measured from the +X-axis. Accordingly, λ=0° in the direction of the prime meridian and increases eastward from the prime meridian. Thus, the +Y direction points along the line toward meridian 110 at λ=+90°. Note that A may be reckoned as strictly positive, ranging from 0° to 360°, or as positive eastward, from 0° to 180° “east longitude,” and negative westward, from 0° to 180° “west longitude.” Further, λ may be measured in units of radians or other common units of angle. These or other conventional definitions of longitude may be used without limiting the scope and spirit of the present invention.

Geodetic latitude φ of a given point is measured in a meridian plane containing the given point as the angle between the equatorial plane and a line, also lying in the meridian plane, that extends from the equatorial plane through the given point, and intersects of the reference ellipsoid at a normal angle (i.e., at 90° to the surface of the ellipsoid). For a perfect sphere, all such lines would be radial, intersecting the equatorial plane at the origin. However, for an ellipsoid with rotational symmetry about the polar axis and its major axis in the equatorial plane, the intersection of such a line with the equatorial plane generally lies at some distance from the origin, along the intersection of the meridian and equatorial planes. Geodetic latitude is typically reckoned from 0° in the equatorial plane to +90° in the +Z direction or to −90° in the −Z direction. Positive latitude and negative latitudes are also conventionally referred to as “north” and “south” latitudes, respectively. As with longitude, latitude may be measured in units of radians or other common units of angle, and these or other conventional definitions of latitude may be used without limiting the scope and spirit of the present invention.

Geodetic altitude h of a given point is measured as a distance above or below the surface of the reference ellipsoid, where the line along which the distance is measured is normal to the surface of the ellipsoid. Note that this line is coincident with the line described above for measuring latitude. Geodetic altitude can be measured in any suitable distance unit (e.g., kilometers, meters, feet, miles, etc.) without limitation with respect to the present invention.

In addition to the semi-major and semi-minor axes, the reference ellipsoid may be characterized in terms of additional parameters derived from a and b, as follows:

Eccentricity:

$$ɛ = \sqrt{1 - \frac{{b}^{2}}{{a}^{2}}}$$

Flattening: f=1−b/a

Inverse flattening: 1/f

Some of the parameters of WGS 84 are given in Table 1. As noted, other models having the same or different parameters may also be used in embodiments of the present invention without limiting its scope or spirit.

TABLE 1

| | |
|---|---|
| Semi-major axis a (m) | 6,378,137.0 |
| Semi-minor axis b (m) | 6,356,752.3142 |
| Eccentricty ε | 0.08181919 |
| Flattening f | 0.00335281 |
| Inverse flattening | 298.2572220 |

### 2. Mathematical Formulation

As defined above, a meridian plane is bounded along one edge by the polar axis, thereby intersecting just half of the reference ellipsoid. The corresponding meridian thus extends half way around the ellipsoid, from one pole to the other. More generally, a plane that is coincident with a meridian plane but that is not bounded by the polar axis intersects with the entire reference ellipsoid in an ellipse. Taking the intersection of this unbounded plane with the equatorial plane to define an axis E(X, Y), the ellipse of intersection may be described mathematically by the ellipse equation:

$$\frac{{E}^{2}}{{a}^{2}} + \frac{{Z}^{2}}{{b}^{2}} = 1. \qquad ( 2 )$$

As defined herein, the axis E(X, Y) is a radial distance in the equatorial plane and can be expressed as E=±\sqrt{X²+Y²} for all points (X, Y) on the line of intersection of the unbounded plane and the equatorial plane. The ellipse is symmetric about the polar axis, the meridians for +E and −E being mutual reflections of a meridian curve about the Z-axis. Accordingly, there is no loss of generality in taking only the positive root and considering the just the half of this ellipse in a meridian plane. That is, the intersection of a meridian plane with the reference ellipsoid may be taken as being described by equation (2) because of symmetry about the Z-axis.

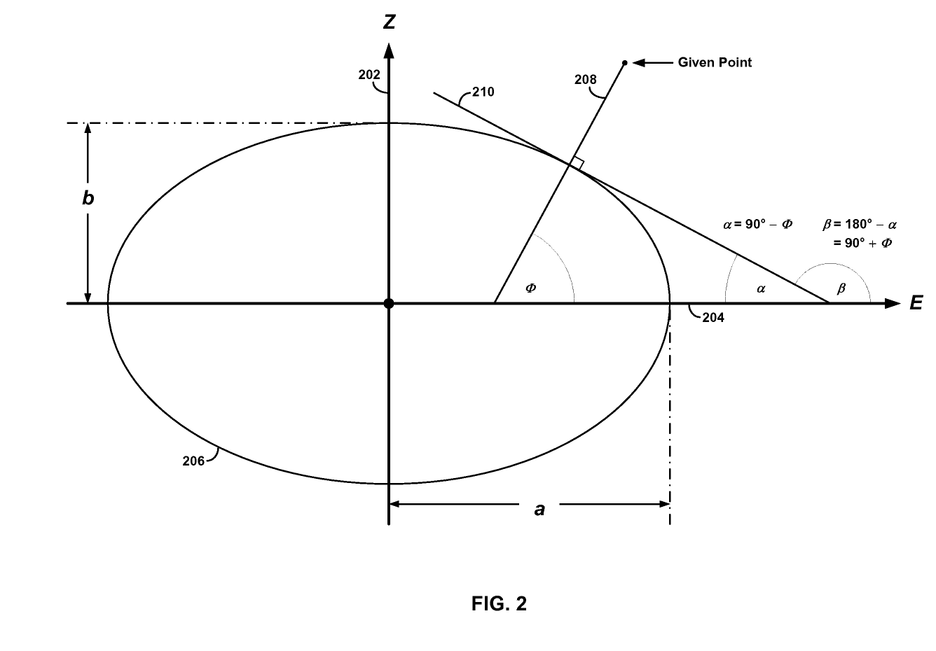

Also, because of rotational symmetry about the polar axis, the transformation of rectangular coordinates of a given point to latitude and altitude of the given point may be derived in a meridian plane that includes the given point. FIG. 2 depicts geometrical aspects of the transformation in a meridian plane bounded by Z-axis 202 and containing E-axis 204 and the given point. The ellipse 206 in the figure is given by equation (2) above; note that the apparent difference in scale between a and b for ellipse 206 is exaggerated in comparison with the WGS 84 values for purposes of illustration. Line 208 extends from the given point (as labeled) to the E-axis and intersects the ellipse at a normal angle (i.e., at 90°). As shown, the angle between line 208 and the E-axis is geodetic latitude φ(X, Y, Z), where the reference to the rectangular coordinates makes the functional relationship of φ and (X, Y, Z) explicit. Because these geometrical relations are restricted to the E-Z plane (for any particular meridian), geodetic latitude can be expressed as φ(X, Y, Z)=φ(E, Z).

Since line 208 is normal to ellipse 206 at the point of intersection, it is equivalently normal to the tangent 210 to ellipse 206 at that point. Therefore, tangent 210 makes an angle α=90°−φ with the E-axis, the complement of which, namely β=180°−α=90°+φ, is the angle of the tangent. Analytically, the tangent to the ellipse is given by dZ/dE, so it follows that:

$$\frac{d Z}{d E} = tan ( 90 ° + Φ ) = - 1 / tan ( Φ ) . \qquad ( 3 )$$

From equation (2), dZ/dE=−Eb²/Za², while from the definition of E it follows that b²/a²=(1−ε²). Combining these expressions yields,

$$\frac{d Z}{d E} = - \frac{E}{Z} ( 1 - {ɛ}^{2} ) = - 1 / tan ( Φ ) , or \\ \frac{Z}{E} = ( 1 - {ɛ}^{2} ) tan ( Φ ) . \qquad ( 4 )$$

Therefore, latitude can be expressed as:

$$Φ ( E , Z ) = {tan}^{- 1} [ \frac{Z}{E ( 1 - {ɛ}^{2} )} ] , \qquad ( 5 )$$

where this formula is valid for points (E, Z) on the ellipse.

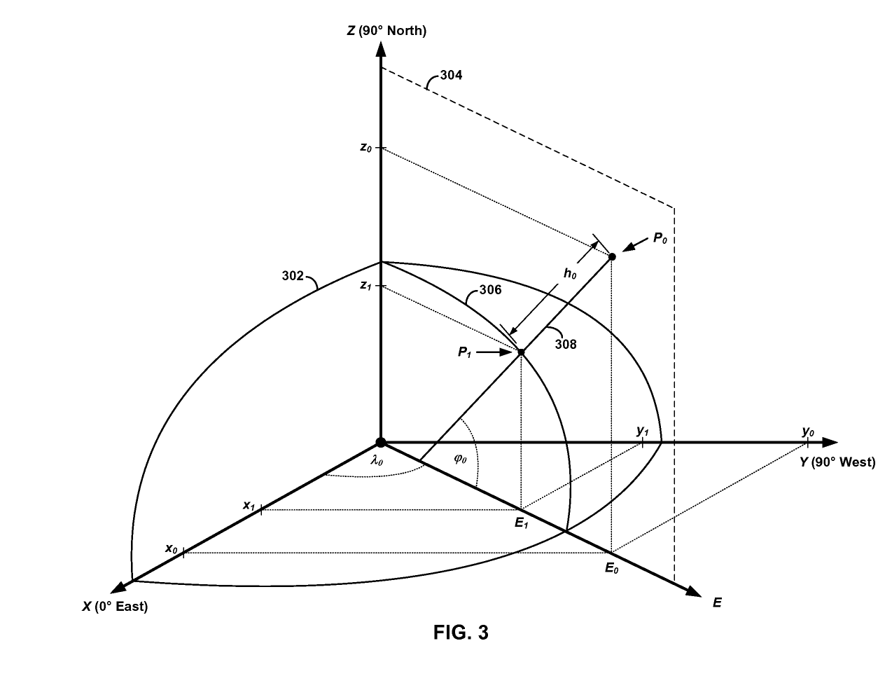

The geometry of the transformation is further illustrated in FIG. 3, which depicts the two-dimensional elements in a three-dimensional context. By way of example, the given point is taken to be at a geodetic longitude that is between 0° and 90°, and a positive (north) latitude. However, because of symmetry, the principles described apply to any range of longitude and/or latitude. In the figure, the surface of reference ellipsoid 302 is represented by its respective intersections with the X-Y, X-Z, and Y-Z planes. Again, the X-Y plane coincides with the equatorial plane. Note that while the label reading “302” points to the reference ellipsoid along a curve that also corresponds to the prime meridian, it should be understood that the label is meant to identify the surface of the ellipsoid.

The given point is designated as P₀, where in terms of rectangular coordinates, P₀=(x₀, y₀, z₀), as illustrated in FIG. 3. In accordance with embodiments described herein, a meridian plane that contains given point P₀ is determined, illustrated in the figure as meridian plane 304. The intersection of meridian plane 304 with reference ellipsoid 302 is meridian 306. As discussed above, meridian 306 may be described according equation (2) for an ellipse. Also depicted is the E-axis, which is the intersection of meridian plane 304 with equatorial plane. Note that only a portion of meridian plane 304 that extends above the equatorial plane (i.e., for +7) and part way along the E-axis is shown, since this is the portion that contains P₀. As shown, geodetic normal 308 lies in the meridian plane, extending from P₀ to the equatorial plane, and intersecting meridian 306 at point P₁. In terms of rectangular coordinates, P₁=(x₁, y₁, z₁), also illustrated in the figure.

The projection of P₀ onto the equatorial plane is the point (x₀, y₀, 0), and corresponds to the point E₀=\sqrt{x₀²+y₀²}, as shown in FIG. 3. Similarly the projection of P₁ onto the equatorial plane is the point (x₁, y₁, 0), and corresponds to the point E₁=\sqrt{x₁²+y₁²}, also shown in the figure. Accordingly, P₀ may be written as P₀=(E₀, z₀), and P₁ may be written as P₁=(E₁, z₁).

The meridian plane may be determined from P₀ according to longitude function:

Λ(X,Y)=tan⁻¹(Y/X), (6)

evaluated at X=x₀ and Y=y₀. That is:

λ₀=Λ(x₀,y₀)=tan⁻¹(y₀/xₒ). (7)

The values of x₀ and y₀ may be used to determine in which quadrant of the X-Y plane P₀ lies, so that the computed value of the arctangent may be appropriately adjusted, if necessary. As illustrated, λ₀ is the angle of the E-axis measured counterclockwise from the X-axis.

With these definitions for P₀ and P₁, the geodetic latitude φ₀ of point P₀ is obtained by evaluating the equation (5) for φ(E, Z) at P₁. That is:

$${ϕ}_{0} = Φ ( {x}_{1} , {y}_{1} , {z}_{1} ) = Φ ( {E}_{1} , {z}_{1} ) = {tan}^{- 1} [ \frac{{z}_{1}}{{E}_{1} ( 1 - {ɛ}^{2} )} ] . \qquad ( 8 )$$

Geodetic latitude φ₀ is also illustrated in FIG. 3.

The geodetic altitude of the given point P₀ may be determined by computing the distance along geodetic normal 308 between P₀ and point P₁. Specifically, the geodetic altitude h₀ of the given point P₀ above (or below) point P₁ on the surface of the reference ellipsoid is obtained by evaluating the altitude function:

H(X,Y,Z)=H(E,Z)=±[(E−E₀)²+(Z−z₀)²]^{1/2} (9)

at point P₁. That is:

h₀=H(x₁,y₁,z₁)=H(E₁,z₁)=[(E₁−E₀)²+(z₁−z₀)²]^{1/2}. (10)

The sign of the square root is positive for positive altitude (P₀ above P₁) and negative for negative altitude (P₀ below P₁). Determining which sign applies in a particular case depends on the relative sizes of z₀ and z₁, as explained below. For the example illustrated in FIG. 3, h₀ is positive.

For a given point P₀, the coordinates of the point P₁ are not a priori known. However, the coordinates of P₁ may advantageously be determined by solving for the intersection of geodetic normal 308 and meridian 306, as presently described. Then with the coordinates of given point P₀ known (e.g., as given) and the coordinates of P₁ derived from computation, equations (5) and (9) for φ(E, Z) and H(E, Z), respectively, may be evaluated to determine geodetic latitude φ₀ and geodetic altitude h₀ in accordance with equations (8) and (10), respectively.

Geodetic normal 308 is normal to the meridian 306 at P₁, so its slope m may be determined as the negative reciprocal of the tangent dZ/dE evaluated at P₁ according to:

$${m = \frac{- 1}{{( \frac{d Z}{d E} ) \vert}_{{P}_{1}}} = \frac{{Za}^{2}}{{Eb}^{2}} \vert}_{{P}_{1}} = \frac{{z}_{1} {a}^{2}}{{E}_{1} {b}^{2}} , \qquad ( 11 )$$

where the meridian is described by equation (2) for an ellipse. Note that this formula for normal slope m applies to any point on meridian 306. In the present case, however, the point P₁ is chosen such that the normal at P₁ is collinear with line connecting P₁ with P₀. Then the line segment between P₀ and P₁ may be expressed as:

$${z}_{0} - {z}_{1} = \frac{{z}_{1} {a}^{2}}{{E}_{1} {b}^{2}} ( {E}_{0} - {E}_{1} ) , \qquad ( 12 )$$

or after some rearranging of terms:

$${z}_{1} = {{z}_{0} ( 1 + \frac{{a}^{2} {E}_{0}}{{b}^{2} {E}_{1}} - \frac{{a}^{2}}{{b}^{2}} )}^{- 1} . \qquad ( 13 )$$

Defining terms C₁ and C₂ as:

C₁=1−(a²/b²), and

C₂=E₀(a²/b²),

equation (13) for the line segment between P₀ and P₁ may be rewritten as:

z₁=z₀E₁(C₁E₁+C₂)⁻¹. (14)

The coordinates of P₁ may advantageously be determined by solving for the intersection of meridian 306 and geodetic normal 308 using the equations (2) and (14).

Specifically, equation (2) for the ellipse may be rewritten with E=E₁ and Z=z₁. Then substituting z₁ from equation (14), E₁ may be determined algebraically from the resulting equation. After some algebraic manipulations, this substitution yields a fourth order equation in E₁ of the form:

b²C₁²E₁⁴+2C₁C₂b²E₁³+(b²C₂²+a²z²−a²b²C₁²)E₁²−2C₁C₂a²b²E₁−a²b²C₂²=0. (15)

Equation (15) has four roots for E₁. Since E₁ corresponds to the projection of the point P₁ onto the equatorial plane, any valid root E₁ must be real. Therefore, any complex or imaginary roots (i.e., roots that are not real) may be excluded from consideration. Further, since P₁ is by definition on the surface of the reference ellipsoid, E₁ can never exceed the equatorial radius of the reference ellipsoid. Since the equatorial radius of the reference ellipsoid is the semi-major axis a, this condition corresponds to E₁≦a. Correspondingly, any root that exceeds the semi-major axis a may be excluded from consideration. Finally, as explained above, only values of +E need to be considered. Therefore, in addition to the conditions that E₁ be real and E₁≦a, any root E₁ of equation (15) must also be positive. In summary, the conditions on E₁ are: E₁ is real and 0≦E₁≦a.

In practice, equation (15) may be solved using any suitable method. Since numerous such methods are well-known in the art, calculations or computations for determining the roots of equation (15) are not discussed herein.

Once E₁ is determined from equation (15), it may be substituted back into equation (2) in order to determine z₁. Specifically, z₁ may be computed from equation (2) recast in the form:

$${z}_{1} = \pm b \sqrt{1 - \frac{{E}_{1}^{2}}{{a}^{2}}} . \qquad ( 16 )$$

The sign of z₁ is selected to be the same as that of z₀. Then with both E₁ and z₁ computed, equation (8) may be evaluated for geodetic latitude φ₀ of given point P₀, and equation (10) may be evaluated for the geodetic altitude h₀ of given point P₀.

From the form of equation (5) or equation (8) for geodetic latitude, it may be seen that the sign of the argument of the arctangent is sign of Z (or z₁). This is because 1−ε² is always positive and E(or E₁) is taken to be positive in any meridian plane, while Z (or z₁) can be positive or negative. Consequently, φ(or φ₀) will carry the sign of Z (or z₁), and no adjustment of the result of the arctangent needs to be made. Note that if it desirable or required to reckon geodetic latitude in terms of “north” or “south,” the sign of Z (or z₁) may be used for this purpose. Specifically, for Z (or z₁) positive, north latitude may be assigned of the result of arctangent. Conversely, for Z (or z₁) negative, south latitude may be assigned the result of the result of arctangent.

The altitude as determined from either of equations (9) or (10) may be positive or negative. P₀ and P₁ are always on the same side of the equatorial plane—that is both above (+Z side) or below (−Z side) of the equatorial plane—so the sign of the altitude will depend on whether z₀ is outside or inside the surface of the reference ellipsoid. Since z₁ is positive when z₀ is positive and z₁ is negative when z₀ is negative, the condition for determining the sign of the altitude is based on a comparison of the absolute values of z₀ and z₁. Specifically, for |z₀|>|z₁|, the altitude determined from equation (10) is taken to be positive. Conversely, for |z₀|<|z₁|, the altitude determined from equation (10) is taken to be negative. When z₀=z₁, then P₀ and P₁ coincide, and the altitude is zero, as expected.

### 3. Sample Calculations

The mathematical formalism described above can be applied to a sample of points in order to illustrate the method and the computed results. The following calculations use the WGS 84 parameters, as defined in Table 1, above.

Consider first a point P₀=(a, a, b). That is, x₀=y₀=semi-major axis a, and z₀=semi-minor axis b. From E₀=\sqrt{x₀²+y₀²}, it follows that E₀=9.02×10⁶ meters (m), and the parameters C₁ and C₂ have values C₁=−0.0067397 and C₂=9.081×10⁶ m. Then solving equation (15) for E₁ yields four solutions (roots):

E₁=+0.5212652×10⁷ m,

E₁=−0.5226011×10⁷ m,

E₁=(0.1347363×10¹⁰+0.9463488×10⁹ i) m, and

E₁=(0.1347363×10¹⁰−0.9463488×10⁹ i) m,

where i=\sqrt{−1}. From the discussion above, all but the first root can be excluded. Then evaluation equation (16) with E₁=+0.5212652×10⁷ m yields z₁=±0.3663122×10⁷ m. Since z₀ is positive, the positive value of z₁ is selected. With these values for E₁ and z₁, geodetic latitude can be computed from equation (8), yielding φ₀=35.3° North. Geodetic longitude can be computed from equation (7) using the given values of x₀ and y₀, yielding λ₀=45°. Finally, geodetic altitude is computed from equation (10), yielding h=0.4663895×10⁷ m. Note that since |z₀|>|z₁|, the altitude determined from equation (10) is taken to be positive, as explained above.

Table 2 lists additional examples of application of the above transformation methodology. For each example, P₀=(x₀, y₀, z₀) is given and λ₀, φ₀, and h₀ are determined in accordance with the method. Note that the first entry corresponds to the sample calculation discussed above. Also note that each of x₀ and y₀ is given either as a factor times semi-major axis a, or as a numerical number of meters, while z₀ is given either as a factor times semi-minor axis b, or as a numerical number of meters. Positive values of φ₀ are designated as North latitude, while negative values are designated South. Positive values of λ₀ are designated as East longitude, while negative values are designated West.

TABLE 2

| x₀ | y₀ | z₀ | φ₀ | λ₀ | h₀ |
|---|---|---|---|---|---|
| (m) | (m) | (m) | (° N or S) | (° E or W) | (10⁷ m) |
| a | a | b | 35.3 | 45.0 | 0.4663895 |
| a | a | 0 | 0.156 × 10⁻¹⁸ | 45.0 | 0.2641911 |
| 1.0 × 10⁻¹⁰ | 1.0 × 10⁻¹⁰ | b | 90.0 | 45.0 | 0.1562599 × 10⁻³³ |
| 1.0 × 10⁻¹⁰ | a | 0 | 0.901 × 10⁻¹⁸ | 90.0 | 0.9966471 × 10⁻²⁰ |
| a | 1.0 × 10⁻¹⁰ | 0 | 0.901 × 10⁻¹⁸ | 0.0 | 0.9966471 × 10⁻²⁰ |
| −a | 1.0 × 10⁻¹⁰ | 0 | 0.901 × 10⁻¹⁸ | 180.0 | 0.9966471 × 10⁻²⁰ |
| 1.0 × 10⁻¹⁰ | −a | 0 | 0.901 × 10⁻¹⁸ | −90.0 | 0.9966471 × 10⁻²⁰ |
| a | −a | 0 | 0.156 × 10⁻¹⁸ | −45.0 | 0.2641911 |
| −a | a | 0 | 0.156 × 10⁻¹⁸ | 135.0 | 0.2641911 |
| −a | −a | 0 | 0.156 × 10⁻¹⁸ | −135.0 | 0.2641911 |
| a√2 | a√2 | 0 | 0.0 | 45.0 | 0.6378138 |
| a | a | 2 b | 54.7 | 45.0 | 0.9224373 |
| a | a | −2 b | −54.7 | 45.0 | 0.9224373 |
| 1.0 × 10⁻¹⁰ | 1.0 × 10⁻¹⁰ | −2 b | −90.0 | 45.0 | 0.6356752 |
| 1.0 × 10⁷ | −2.0 × 10⁷ | −0.2 b | −3.26 | −63.4 | 0.01607582 |

### 4. Exemplary Embodiment of Method of Coordinate Transformation

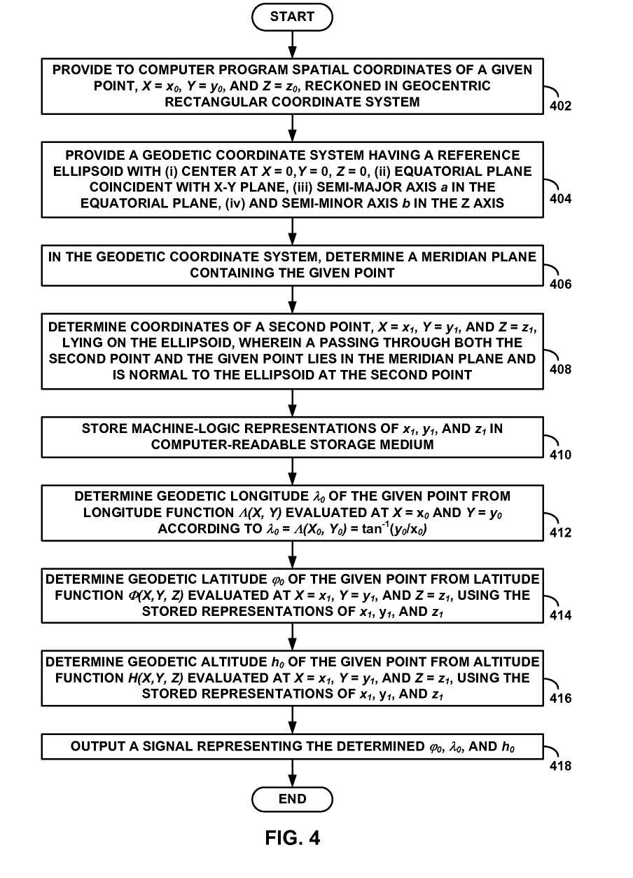

An exemplary embodiment of the a method of transforming geocentric rectangular coordinates to geodetic coordinates based on the mathematical formulation described above is illustrated in the form of a flow chart in FIG. 4. The steps of the flow chart are exemplary of a method carried out in a system comprising a computer processor coupled with a computer-readable storage medium. Preferably, the method is implemented in a computer program (i) comprising machine-language logic instructions stored on the computer-readable storage medium and (ii) being executable by the computer processor.

At step 402, spatial coordinates of a given point reckoned in a geocentric rectangular coordinate system are provided to the computer program. These coordinates correspond to given point P₀ with X=x₀, Y=y₀, and Z=z₀, described above in connection with the mathematical formulation, and may be provided by a user entering them via a user interface, such as a keypad, for example. Alternatively, the coordinates could be supplied automatically from a monitoring device communicatively coupled with the system. For instance, a receiving antenna and transceiver could receive information indicative of the coordinates of P₀ from a GPS satellite or other transmitting facility, and then provide appropriately formatted data to the program via a communicative link to the system. It will be appreciated that other means of providing the coordinates of the given point to the program are possible as well.

A geodetic coordinate system is provided as step 404. As described above, such as system comprises a reference ellipsoid with (i) a center at X=0, Y=0, and Z=0, (ii) an equatorial plane coincident with the X-Y plane, (iii) a semi-major axis a in the equatorial plane and (iv) a semi-minor axis b in the Z-axis. The ellipsoid may be described mathematically according to equation (1), and provides a smooth representation of the surface of the Earth. Providing the geodetic coordinate system could comprise encoding its mathematical representation into the program, for example. As discussed above, WGS 84 is exemplary of such a geodetic coordinate system.

At step 406, a meridian plane in the geodetic coordinate system is determined such that the given point lies in the plane. In accordance with the mathematical description above, equation (7) may be used to determine this meridian plane. That is, equation (7) gives the longitude of the given point, which in turn corresponds to the line of intersection of the meridian plane containing the given point with the equatorial plane.

At step 408, the coordinates of a second point are determined such that the second point lies on the surface of the reference ellipsoid, wherein a line passing through both the second point and the given point lies in the meridian plane and is normal to the ellipsoid at the second point. This second point corresponds to P₁ with X=x₁, Y=y₁, and Z=z₁. Preferably, the coordinates of the second point are determined using equations (2) and (14) in accordance with the discussion of equations (11)-(16), for example. As noted, the coordinates so determined lie in the meridian plane, so that the X and Y coordinates are represented by an E coordinate, where E is an axis corresponding to the intersection of the meridian plane with the equatorial plane.

Once the coordinates of the second point are determined, they are then stored in the form of machine-logic representations in the computer-readable storage medium of the system, as indicated at step 410. By way of example, the computer-readable storage medium could comprise, without limitation, any or all forms of memory including magnetic disk, random access memory (RAM), internal processor registers, and solid state memory devices. Note that “RAM” is a term of art, and does not necessarily imply randomness in the organization of the memory contents or locations or in the processes or actions employed to read or write memory contents. Also by way of example, machine-logic representations of the determined coordinates could include, without limitation, binary data comprising bits and/or bytes in various formats such as binary, text strings, floating-point numbers, and integers, to name a few.

At step 412, geodetic longitude 20 of the given point is determined from a longitude function Λ(X, Y) evaluated at X=x₀ and Y=y₀ according to λ₀=Λ(x₀, y₀)=tan⁻¹(y₀/x₀). As described in connection with step 406, this longitude corresponds to the intersection with the equatorial plane of the meridian containing the given point.

At step 414, geodetic latitude φ₀ of the given point is determined using the stored representations of x₁, y₁, and z₁ to evaluate a latitude function φ(X, Y, Z) at X=x₁, Y=y₁, and Z=z₁. As discussed above, the latitude function corresponds to an angle between the normal line and the equatorial plane at a point of intersection between the line and the equatorial plane. Preferably, the determination of the geodetic latitude of the given point will be made using equation (8), in accordance with the related discussion above of this equation. Again, the X and Y coordinates are represented by the E coordinate.

Geodetic altitude h₀ of the given point is determined at step 416, using the stored representations of x₁, y₁, and z₁ to evaluate an altitude function H(X, Y, Z) at X=x₁, Y=y₁, and Z=z₁. The altitude function corresponds to the distance between the given point and the second point as measured along the normal line connecting the two points. Preferably, the determination of the geodetic altitude of the given point will be made using equation (10), in accordance with the related discussion above of this equation. Once more, the X and Y coordinates are represented by the E coordinate.

Finally, at step 418, a signal representing the determined geodetic latitude φ₀, longitude λ₀, and altitude h₀, is output from the program. This output represents the spatial coordinates of the given point transformed to coordinates of the geodetic coordinate system. Note that the output could be presented on a display device, or serve as input to one or more additional computer programs that further process or manipulate machine-logic representations of φ₀, λ₀, and h₀. Other uses of the output are possible as well.

It will be appreciated that the steps shown in FIG. 4 are exemplary of a method of coordinate transformation based on the mathematical formulation described hereinabove. As such, additional and/or alternative steps consistent with the mathematical formulation may be carried out without departing from the scope and spirit of the present invention.

### 5. Exemplary Embodiment of System for Coordinate Transformation

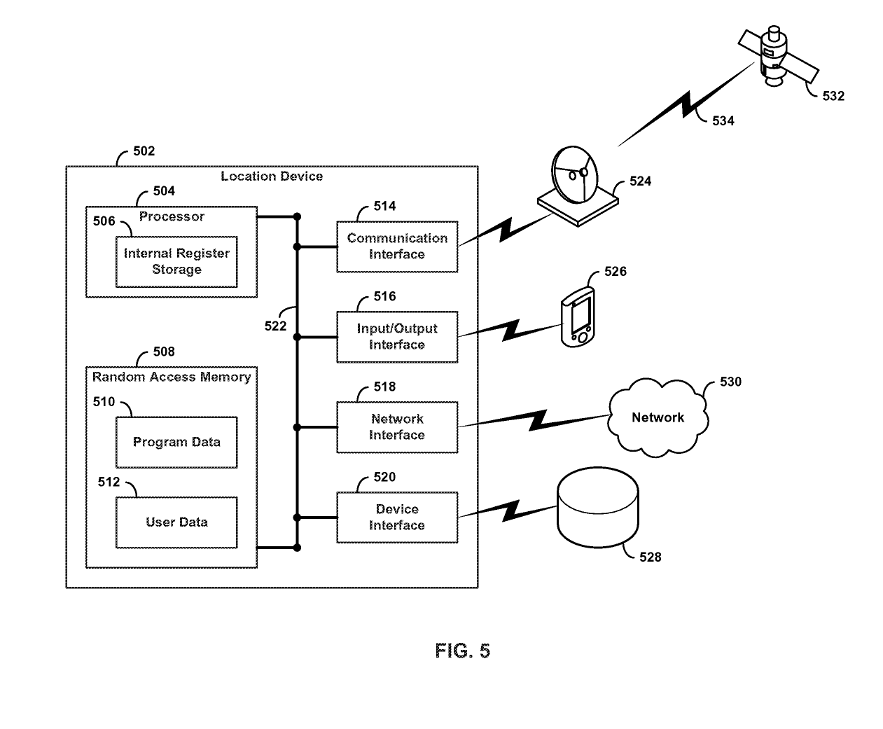

An exemplary embodiment of a system for transforming geocentric rectangular coordinates to geodetic coordinates in accordance with the method described above is depicted in FIG. 5. As shown, the exemplary system comprises location device 502 that includes a processor 504, random access memory 508, communication interface 514, input/output interface 516, network interface 518, and device interface 520, all of which are communicatively coupled by way of system bus 522. In addition, location device 502 is communicatively connected (as represented by “lightning-bolt” lines) to external elements and/or entities by way of one or another of its internal interfaces, as described below. Location device 502 could be any one of a number of devices employed in connection with location services or functionality. Examples of such a device include, without limitation, an automobile navigation device/display, an aircraft navigation instrument, and a handheld location-determination monitor. Location services or functionality could include, without limitation, cartographic location monitoring, mission-critical navigation, and emergency services location determination. It should be understood that other device types are possible, as are other types of location services and functionality.

Processor 504 could comprise one or more general purpose or custom processors, including, without limitation, a single processor, a multiprocessor array, one or more application-specific integrated circuits (ASICs), or one more field-programmable gate arrays (FPGAs). Preferably, processor 504 is capable of executing machine-language logic instructions, such as those making up a computer program for implementing the method and steps described herein. By way of example, processor 504 is shown to include internal register storage 506, which could represent one form of computer-readable storage media. It will be appreciated that internal register storage could comprise one or more storage register locations that are accessible to processor 504 for storage and manipulation of data and instructions, including machine-logic representations of data related to the method described herein.

Random access memory 508 is shown to comprise program data 510 and user data 512, this representation being, again, by way of example. Program data 510 could include, without limitation, machine-language instructions for carrying out the method and associated steps described herein. User data 512 could include information entered by a user of location device 502 in the course of commanding the device to execute the transformation functionality.

Communication interface 514 may provide a communicative connection between location device 502 and one or more external communication entities. By way of example, communication interface 514 is connected to transceiver 524, which in turn is communicatively linked to GPS satellite 532 by way of telemetry link 534.

Input/output interface 516 provides a communicative connection to one or more external input/output devices, such as handheld device 526. In an exemplary configuration, handheld device could be a portable navigation instrument that enables a user to enter location information, and that displays transformed coordinates. Such a device could have additional functionality as well.

Network interface 518 preferably provides access to an external communication network. Such a network could include, without limitation, a circuit-switch landline network (e.g., a PSTN), a wireless network (e.g., a cellular network based on CDMA and/or GSM), or a packet-data network (e.g., an internet or intranet). As such, network interface 518 could comprise a cellular radio-frequency connection (e.g., based CDMA and/or GSM), or a wireless local area network connection (e.g., using WiFi and/or IEEE 802.11 protocols), or some combination of these and/or other types of network connections.

Device interface 520 preferably provides communication connection to one or more other types of external devices. By way of example, device interface 520 is shown to be connected to external disk drive 528, which is representative of another form of computer-readable storage medium.

In exemplary operation of the location device 502, information indicative of the coordinates of a given point P₀ reckoned in geocentric rectangular coordinates could be received at communication interface 514 from GPS satellite 532 via telemetry link 534, then provided to user data 512 for transformation processing via system bus 522. A geodetic coordinate system, such as WGS 84, could be provided in the form of data and machine logic instructions stored in program data 510.

Determination of a meridian plane containing the given point could then be carried out by execution of machine-language instructions for this purpose stored in program data 510. Similarly, machine-language instructions stored in program data 510 will preferably be executed in to determine the coordinates of point P₁ as described in connection with the method steps above and in accordance with the mathematical description upon which the method is based. The machine logic representations of the determined coordinates of P₁ could then be stored in one or more of the forms of computer-readable storage media that are part of the system (e.g., internal register storage 506, random access memory 508, and external disk drive 528).

Machine-language instructions stored in program data 510 will similarly be executed in to determine geodetic longitude, latitude geodetic altitude, also as described in connection with the method steps above and in accordance with the mathematical description upon which the method is based. The machine logic representations of the determined coordinates of P₁ stored in one or more of the forms of computer-readable storage media will preferably be used in the determination of geodetic latitude and altitude, as described above.

Finally, machine-language instructions stored in program data 510 will be executed to output a signal representing the determined geodetic latitude, longitude, and altitude. As noted, this output signal could then be used to display the transformed coordinates, for example on handheld device 526. Alternatively or additionally, the output could serve as input to one or more other programs executing on processor 504. Again, other uses of the output signal are possible as well.

It will be appreciated that location device 502 and any or all of external entities 524, 526, and 530 could be integrated within a single hardware platform. Further, the particular configuration illustrated in FIG. 5 should not be viewed as limiting with respect to present invention. More generally, the entities and components illustrated in FIG. 5 are representative of means for carrying out the method of transforming geocentric rectangular coordinates to geodetic coordinates in accordance with the mathematical formulation described herein.

### 6. CONCLUSION

An exemplary embodiment of the present invention has been described above. Those skilled in the art will understand, however, that changes and modifications may be made to the embodiment described without departing from the true scope and spirit of the invention, which is defined by the claims.

What is claimed:

1. In a system comprising a computer processor coupled with a computer-readable storage medium, a method of transforming and outputting geographic location coordinates, the method being implemented in a computer program (i) comprising machine-language logic instructions stored on the computer-readable storage medium and (ii) being executable by the computer processor, the method comprising:
providing to the computer program spatial coordinates of a given point reckoned in a geocentric rectangular coordinate system, the geocentric rectangular coordinate system comprising three mutually orthogonal axes X, Y, and Z, wherein the spatial coordinates of the given point are X=x₀, Y=y₀, and Z=z₀;
providing a geodetic coordinate system comprising a reference ellipsoid with (i) a center at X=0, Y=0, and Z=0, (ii) an equatorial plane coincident with the X-Y plane, (iii) a semi-major axis a in the equatorial plane and (iv) a semi-minor axis b in the Z-axis, the ellipsoid thereby being of the form:
$$\frac{{X}^{2}}{{a}^{2}} + \frac{{Y}^{2}}{{a}^{2}} + \frac{{Z}^{2}}{{b}^{2}} = 1 ,$$
the surface of the reference ellipsoid being a smooth representation of the surface of the Earth;
in the geodetic coordinate system, determining a meridian plane containing the given point;
determining spatial coordinates X=x₁, Y=y₁, and Z=z₁ of a second point lying on the ellipsoid, wherein a line passing through both the second point and the given point lies in the meridian plane and is normal to the ellipsoid at the second point; storing machine-logic representations of x₁, y₁, and z₁ in the computer-readable storage medium;
determining a geodetic longitude 20 of the given point from a longitude function Λ(X, Y) evaluated at X=x₀ and Y=y₀ according to λ₀=Λ(x₀, y₀)=tan⁻¹(y₀/x₀);
determining a geodetic latitude φ₀ of the given point using the stored representations of x₁, y₁, and z₁ to evaluate a latitude function φ(X, Y, Z) at X=x₁, Y=y₁, and Z=z₁, the latitude function giving an angle between the line and the equatorial plane at a point of intersection between the line and the equatorial plane;
determining a geodetic altitude h₀ of the given point using the stored representations of x₁, y₁, and z₁ to evaluate an altitude function H(X, Y, Z) at X=x₁, Y=y₁, and Z=z₁, the altitude function giving a length of the line between the given point and the second point; and
outputting a signal representing the determined geodetic latitude φ₀, longitude λ₀, and altitude h₀, wherein φ₀, λ₀, and h₀ are the spatial coordinates of the given point transformed to coordinates of the geodetic coordinate system.

2. The method of claim 1, wherein:
E(X, Y) is an axis defined by the intersection of the meridian plane with the equatorial plane, the intersection of the ellipsoid with the meridian plane thereby being an ellipse described by an ellipse equation Z²a²=a²b²−E²b²,
E₀ is a radial distance measured along the E axis of a projection of the given point onto the equatorial plane, E₀ being equal to \sqrt{x₀²+y₀²},
E₁ is a radial distance measured along the E axis of a projection of the second point onto the equatorial plane, E₁ corresponding to \sqrt{x₁²+y₁²},
$${C}_{1} = 1 - ( {a}^{2} / {b}^{2} ) , \\ {C}_{2} = {E}_{0} ( {a}^{2} / {b}^{2} ) , \\ ɛ = \sqrt{1 - \frac{{b}^{2}}{{a}^{2}}} ,$$
and wherein determining the spatial coordinates X=x₁, Y=y₁, and Z=z₁ of the second point comprises:
computing E₁ as a real root of the equation:
b²C₁²E₁⁴+2C₁C₂b²E₁³+(b²C₂²+a²z₀²−a²b²C₁²)E₁²−2C₁C₂a²b²E₁−a²b²C₂²=0; and
evaluating the ellipse equation using the computed E₁ value, thereby determining coordinate value z₁ according to z₁²a²=a²b²−E₁²b²;
and wherein storing the machine-logic representations of x₁, y₁, and z₁ in the computer-readable storage medium comprises storing machine-logic representations of the computed E₁ value and the determined coordinate value z₁ in the computer-readable storage medium.

3. The method of claim 2, wherein the latitude function is given by φ(X, Y, Z)=tan⁻¹[Z/(E(1−ε²))], and wherein determining the geodetic latitude φ₀ of the given point comprises evaluating the latitude function at X=x₁, Y=y₁, and Z=z₁ according to:
$${ϕ}_{0} = Φ ( {x}_{1} , {y}_{1} , {z}_{1} ) = {tan}^{- 1} [ \frac{{z}_{1}}{{E}_{1} ( 1 - {ɛ}^{2} )} ] ,$$
using the stored representations of E₁ and z₁.

4. The method of claim 2, wherein the altitude function is given by H(X, Y, Z)=[(E−E₀)²+(Z−z₀)²]^{1/2}, and wherein determining the geodetic altitude h₀ of the given point comprises evaluating the altitude function at X=x₁, Y=y₁, and Z=z₁ according to:
h₀=H(x₁,y₁,z₁)=[(E₁−E₀)²+(z₁−z₀)²]^{1/2},
using the stored representations of E₁ and z₁.

5. The method of claim 2, wherein computing E₁ as a real root comprises:
excluding any root that is not real;
excluding any real root that has an absolute value greater than the semi-major axis a; and
excluding any real root that is negative.

6. The method of claim 2, wherein evaluating the ellipse equation comprises:
computing z₁ according to z₁=sign(z₀)×b[1−(E₁/a)²]^{1/2} using the computed E₁ value, wherein sign(z₀)=+1 if z₀>0 and sign(z₀)=−1 if z₀<0.

7. The method of claim 4, wherein evaluating the altitude function at X=x₁, Y=y₁, and Z=z₁ according to h₀=H(x₁,y₁,z₁)=[(E₁−E₀)²+(z₁−z₀)²]^{1/2} comprises:
evaluating h₀ according to h₀=+[(E₁−E₀)²+(z₁−z₀)²]^{1/2} if |z₀|>|z₁|; and
evaluating h₀ according to h₀=−[(E₁−E₀)²+(z₁−z₀)²]^{1/2} if |z₀|<|z₁|.

8. The method of claim 1, wherein outputting the signal representing the determined geodetic latitude φ₀, longitude λ₀, and altitude h₀ comprises:
outputting the determined geodetic latitude φ₀, longitude λ₀, and altitude h₀ to a display device; and
on the display device, displaying the outputted geodetic latitude φ₀, longitude λ₀, and altitude h₀.

9. The method of claim 1, wherein outputting the signal representing the determined geodetic latitude φ₀, longitude λ₀, and altitude h₀ comprises providing the determined geodetic latitude φ₀, longitude λ₀, and altitude h₀ to an input function of another computer program executing on the computer processor.

10. The method of claim 1, wherein providing the geodetic coordinate system comprising a reference ellipsoid comprises providing a geodetic coordinate system comprising a reference ellipsoid defined according to WGS 84.

11. A system for transforming and outputting geographic location coordinates, the system comprising:
a computer-readable storage medium;
a computer processor coupled with the computer-readable storage medium;
machine-language logic instructions stored on the computer-readable storage medium and executable by the computer processor to:
receive spatial coordinates of a given point reckoned in a geocentric rectangular coordinate system, the geocentric rectangular coordinate system comprising three mutually orthogonal axes X, Y, and Z, wherein the spatial coordinates of the given point are X=x₀, Y=y₀, and Z=z₀;
render a geodetic coordinate system comprising a reference ellipsoid with (i) a center at X=0, Y=0, and Z=0, (ii) an equatorial plane coincident with the X-Y plane, (iii) a semi-major axis a in the equatorial plane and (iv) a semi-minor axis b in the Z-axis, the ellipsoid thereby being of the form:
$$\frac{{X}^{2}}{{a}^{2}} + \frac{{Y}^{2}}{{a}^{2}} + \frac{{Z}^{2}}{{b}^{2}} = 1 ,$$
the surface of the reference ellipsoid being a smooth representation of the surface of the Earth;
determine a meridian plane containing the given point;
determine spatial coordinates X=x₁, Y=y₁, and Z=z₁ of a second point lying on the ellipsoid, wherein a line passing through both the second point and the given point lies in the meridian plane and is normal to the ellipsoid at the second point;
store machine-logic representations of x₁, y₁, and z₁ in the computer-readable storage medium;
determine a geodetic longitude 21 of the given point from a longitude function Λ(X, Y) evaluated at X=x₀ and Y=y₀ according to λ=Λ(x₀, y₀)=tan⁻¹(y₀/x₀);
determine a geodetic latitude φ₀ of the given point using the stored representations of x₁, y₁, and z₁ to evaluate a latitude function φ(X, Y, Z) at X=x₁, Y=y₁, and Z=z₁, the latitude function giving an angle between the line and the equatorial plane at a point of intersection between the line and the equatorial plane;
determine a geodetic altitude h₀ of the given point using the stored representations of x₁, y₁, and z₁ to evaluate an altitude function H(X, Y, Z) at X=x₁, Y=y₁, and Z=z₁, the altitude function giving a length of the line between the given point and the second point; and
output a signal representing the determined geodetic latitude φ₀, longitude λ₀, and altitude h₀, wherein φ₀, λ₀, and h₀ are the spatial coordinates of the given point transformed to coordinates of the geodetic coordinate system.

12. The system of claim 11, wherein:
E(X, Y) is an axis defined by the intersection of the meridian plane with the equatorial plane, the intersection of the ellipsoid with the meridian plane thereby being an ellipse described by an ellipse equation Z²a²=a²b²E²b²,
E₀ is a radial distance measured along the E axis of a projection of the given point onto the equatorial plane, E₀ being equal to \sqrt{x₀²+y₀²},
E₁ is a radial distance measured along the E axis of a projection of the second point onto the equatorial plane, E₁ corresponding to \sqrt{x₁²+y₁²},
$${C}_{1} = 1 - ( {a}^{2} / {b}^{2} ) , \\ {C}_{2} = {E}_{0} ( {a}^{2} / {b}^{2} ) , \\ ɛ = \sqrt{1 - \frac{{b}^{2}}{{a}^{2}}} ,$$
and wherein the machine-language logic instructions stored on the computer-readable medium and executable by the computer processor to determine the spatial coordinates X=x₁, Y=y₁, and Z=z₁ of the second point comprise machine-language logic instructions executable by the computer processor to:
compute E₁ as a real root of the equation:
b²C₁²E₁⁴+2C₁C₂b²E₁³+(b²C₂²+a²z₀²−a²b²C₁²)E₁¹−2C₁C₂a²b²E₁−a²b²C₂²=0;
and
evaluate the ellipse equation using the computed E₁ value, and thereby determine coordinate value z₁ according to z₁²a²=a²b²−E₁²b²;
and wherein the machine-language logic instructions stored on the computer-readable medium and executable by the computer processor to store the machine-logic representations of x₁, y₁, and z₁ in the computer-readable storage medium comprise machine-language logic instructions executable by the computer processor to store machine-logic representations of the computed E₁ value and the determined coordinate value z₁ in the computer-readable storage medium.

13. The system of claim 12, wherein the latitude function is given by φ(X, Y, Z)=tan⁻¹[Z/(E(1−ε²))], and wherein the machine-language logic instructions stored on the computer-readable medium and executable by the computer processor to determine the geodetic latitude φ₀ of the given point comprise machine-language logic instructions executable by the computer processor to evaluate the latitude function at X=x₁, Y=y₁, and Z=z₁ according to:
$${ϕ}_{0} = Φ ( {x}_{1} , {y}_{1} , {z}_{1} ) = {tan}^{- 1} [ \frac{{z}_{1}}{{E}_{1} ( 1 - {ɛ}^{2} )} ] ,$$
using the stored representations of E₁ and z₁.

14. The system of claim 12, wherein the altitude function is given by H(X, Y, Z)=[(E−E₀)²+(Z−z₀)²]^{1/2}, and wherein the machine-language logic instructions stored on the computer-readable medium and executable by the computer processor to determine the geodetic altitude h₀ of the given point comprise machine-language logic instructions executable by the computer processor to evaluate the altitude function at X=x₁, Y=y₁, and Z=z₁ according to:
h₀=H(x₁,y₁,z₁)=[(E₁−E₀)²+(z₁−z₀)²]^{1/2},
using the stored representations of E₁ and z₁.

15. The system of claim 12, wherein the machine-language logic instructions executable by the computer processor to compute E₁ as a real root comprise machine-language logic instructions executable by the computer processor to:
exclude any root that is not real;
exclude any real root that has an absolute value greater than the semi-major axis a; and
exclude any real root that is negative.

16. The system of claim 12, wherein the machine-language logic instructions executable by the computer processor to evaluate the ellipse equation comprise machine-language logic instructions executable by the computer processor to:
compute z₁ according to z₁=sign(z₀)×b[1−(E₁/a)²]^{1/2} using the computed E₁ value, wherein sign(z₀)=+1 if z₀>0 and sign(z₀)=−1 if z₀<0.

17. The method of claim 14, wherein the machine-language logic instructions executable by the computer processor to evaluate the altitude function at X=x₁, Y=y₁, and Z=z₁ according to h₀=H(x₁,y₁,z₁)=[(E₁−E₀)²+(z₁−z₀)²]^{1/2} comprise machine-language logic instructions executable by the computer processor to:
evaluate h₀ according to h₀=+[(E₁−E₀)²+(z₁−z₀)²]^{1/2} if |z₀|>|z₁|; and
evaluate h₀ according to h₀=−[(E₁−E₀)²+(z₁−z₀)²]^{1/2} if |z₀|<|z₁|.

18. The system of claim 11, further comprising a display device, and wherein the machine-language logic instructions executable by the computer processor to output the signal representing the determined geodetic latitude φ₀, longitude λ₀, and altitude h₀ comprise machine-language logic instructions executable by the computer processor to:
output the determined geodetic latitude φ₀, longitude λ₀, and altitude h₀ to the display device; and
display the outputted geodetic latitude φ₀, longitude λ₀, and altitude h₀ on the display device.

19. The system of claim 11, wherein the machine-language logic instructions executable by the computer processor to output the signal representing the determined geodetic latitude φ₀, longitude λ₀, and altitude h₀ comprise machine-language logic instructions executable on the computer processor to provide the determined geodetic latitude φ₀, longitude λ₀, and altitude h₀ to an input function of another computer program executing on the computer processor.

20. The system of claim 11, wherein the machine-language logic instructions executable by the computer processor to render the geodetic coordinate system comprising a reference ellipsoid comprise machine-language logic instructions executable on the computer processor to render a geodetic coordinate system comprising a reference ellipsoid defined according to WGS 84.
